(19) United States
(12) Patent Application Publication
(10) Pub. No.: US 2010/0242102 A1
(43) Pub. Date: Sep. 23, 2010

(54) Biometric credential verification framework

(75) Inventors: David B. Cross, Redmond, WA (US); Paul J. Leach, Seattle, WA (US); Klaus U. Schutz, Kirkland, WA (US); Robert D. Young, Kirkland, WA (US); Nathan C. Sherman, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/477,160

(22) Filed: Jun. 27, 2006

(51) Int. Cl. G06F 21/00; H04L 29/06; H04L 9/08

(52) U.S. Cl. 726/7; 726/10; 380/278

(57) ABSTRACT

Use of a biometric identification device in a client computer system to subsequently access an authentication system includes receiving biometric sample data which is digitally signed and combining the data with a user ID and PIN. This package of data is then securely transmitted to a biometric matching server to validate the user and the biometric sample. Once validated, the biometric matching server return the data package plus a temporary certificate and a public/private key pair to the client computer. The client computer may then use this information to access an authentication system to subsequently gain access to a secure resource.

### BACKGROUND

Biometric samples used for interactive user or network authentication are different from the traditional password or cryptographic key used in current authentication schemes in that they differ every time they are sampled. Biometric samples are not ideal for cryptographic key material for several reasons. They have limited strength and the entropy of a cryptographic seed can be regenerated or changed. Biometric samples are not absolute values; they are samples and may differ from one sampling to the next. Cryptographic keys are absolutes defined from an original seed whereas biometric readings vary. Because of these limitations, biometric samples are not optimum choices for cryptographic key material.

Biometric samples are typically matched against a stored sample (often referred to in the industry as a “template”) that was previously scanned and/or computed, and if a live match with a stored sample is validated, then stored cryptographic key material is released to the system to allows a user login session to proceed using that key material. However, if the matching process and/or key storage is done outside a secure environment, such as a physically secure server, the key material and/or reference template is subject to attacks and disclosure.

The current Windows™ architecture provided by Microsoft® Corporation of Redmond, Wash. supports password or Kerberos/PKINIT authentication, but does not support matching of biometric templates on the server as a normal part of authentication. Solutions provided today by biometric solution vendors typically store traditional login credentials such as passwords or x.509 based certificates on the client machines and then submit them after a valid template match against a reference biometric sample that is also stored on the client PC. In the current systems, the passwords, x.509 based certificates and reference templates are all subject to attack and disclosure because they reside outside the physically secured servers.

It is therefore desirable to provide a system or method that uses biometric identification in a secure environment. The present invention addresses these and other concerns.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An advance in the use of biometric identification for access to an authentication system such as a Windows or Active Directory based domain infrastructure includes acquisition of biometric data from a user and inputting a user ID and PIN to a client computer. The client computer securely communicates with a biometric matching server which can match the user biometric data with a set of templates of biometric data for the user. The biometric server can verify that the user is authorized and identified. Once verified, the matching server transmits a temporary certificate along with cryptographic keys to the client computer. The temporary certificate and the keys are used to gain immediate access to the Kerberos authentication system. Subsequent use of the temporary certificate by the client will result in denied access to the Kerberos authentication system because the certificate has expired. Once the client computer gains access to the Kerberos system, then subsequent access to a secure set of computing resources may be obtained.

### BRIEF DESCRIPTION OF THE DRAWINGS

In the drawings:

FIG. 1 is a block diagram showing a prior art authentication system;

FIG. 2 is an example block diagram depicting functional aspects of the invention;

FIG. 3 is an example flow diagram showing an embodiment of the invention; and

FIG. 4 is a block diagram showing an example host computing environment.

### DETAILED DESCRIPTION

### Exemplary Embodiments

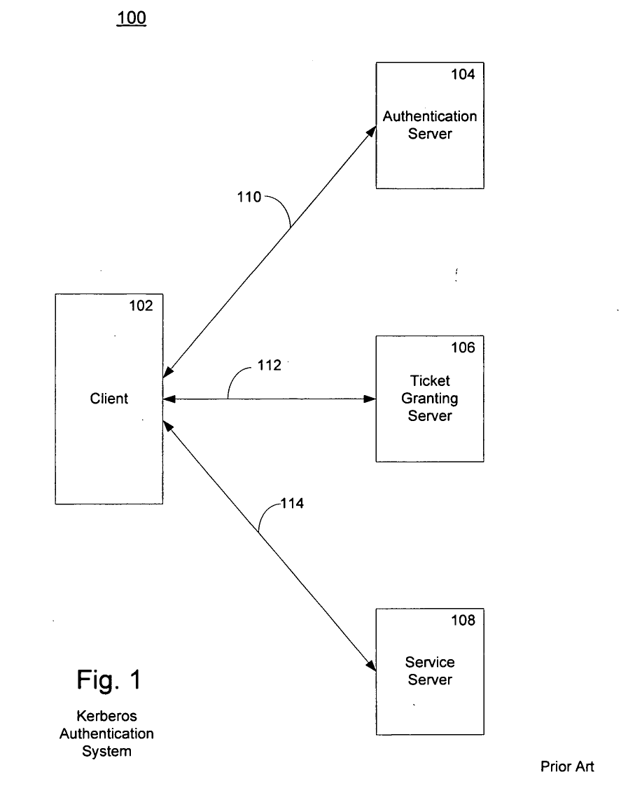

The present invention functions well with a secure authentication computing system environment. One such existing authentication system environments is well known to those of skill in the art as Kerberos. FIG. 1 is a block diagram of a typical Kerberos System. Kerberos is a computer network authentication protocol which allows individuals communicating over an insecure network to prove their identity to one another in a secure manner. Kerberos prevents eavesdropping or replay attacks, and ensures the integrity of the data. Kerberos provides mutual authentication where both the user and the service verify each other's identity. Kerberos builds on symmetric key cryptography and requires a trusted third party.

Kerberos includes two functional parts: an Authentication Server (AS) 104 and a Ticket Granting Server (TGS) 106. Kerberos works on the basis of “tickets” which serve to prove the identity of users. Using Kerberos, a client 102 can prove its identity to use the resources of a service server (SS) 108. Kerberos maintains a database of secret keys; each entity on the network, whether a client or a server, shares a secret key known only to itself and to Kerberos. Knowledge of this key serves to prove an entity's identity. For communication between two entities, Kerberos generates a session key which they can use to secure their interactions.

Using the Kerberos system, the client authenticates itself to an AS 104, then demonstrates to the TGS 106 that it's authorized to receive a ticket for a service (and receives it), then demonstrates to the SS that it has been approved to receive the service. The process begins when a user enters a username and password on the client 102. The client performs a one-way hash on the entered password, and this becomes the secret key of the client. The client sends a clear-text message to the AS 104 via link 110 requesting services on behalf of the user. At this point, neither the secret key nor the password is sent to the AS.

The AS 104 checks to see if the client 102 is in its database. If it is, the AS sends back the following two messages to the client via link 110:

*Message A: A client/TGS session key encrypted using the secret key of the user and
*Message B: A Ticket-Granting Ticket (which includes the client ID, client network address, ticket validity period, and the client/TGS session key) encrypted using the secret key of the TGS.
Once the client receives messages A and B, it decrypts message A to obtain the client/TGS session key. This session key is used for further communications with TGS. (Note: The client cannot decrypt the Message B, as it is encrypted using TGS's secret key.) At this point, the client 102 has enough information to authenticate itself to the TGS.

When requesting services, the client 102 sends the following two messages to the TGS 106 via link 112:

*Message C: Composed of the Ticket-Granting Ticket from message B and the ID of the requested service, and
*Message D: Authenticator (which is composed of the client ID and the timestamp), encrypted using the client/TGS session key.
Upon receiving messages C and D, the TGS 106 decrypts message D (Authenticator) using the client/TGS session key and sends the following two messages to the client 102 via link 112:
*Message E: Client-to-server ticket (which includes the client ID, client network address, validity period) encrypted using the service's secret key, and
*Message F: Client/server session key encrypted with the client/TGS session key.

Upon receiving messages E and F from TGS 106, the client 102 has enough information to authenticate itself to the SS 108. The client 102 connects to the SS 108 via link 114 and sends the following two messages:

*Message G: the client-to-server ticket, encrypted using service's secret key, and
*Message H: a new Authenticator, which includes the client ID, timestamp and is encrypted using client/server session key.

The SS 108 decrypts the ticket using its own secret key and sends the following message to the client 102 via link 114 to confirm its true identity and willingness to serve the client.

*Message 1: the timestamp found in client's recent Authenticator plus 1, encrypted using the client/server session key.
The client 102 decrypts the confirmation using its shared key with the SS 108 and checks whether the timestamp is correctly updated. If so, then the client 102 can trust the SS 108 and can start issuing service requests to the SS 108. The SS 108 can then provide the requested services to the client 102.

The present invention may advantageously use aspects of the Kerberos system with a biometric sampler device. In one environment a new framework may be implemented wherein a claimed user identity, such as a username, domain name, UPN, etc., a PIN/password and a reader-signed cryptographic biometric sample is sent securely to a newly defined Biometric-Matching Server that holds the reference templates for each user that is enrolled in the biometric system. If the claimed identity, PIN/password, signature on the sample, and match are all validated, then a temporary credential, such as an X.509 certificate or a symmetric key or a one-time-password, is generated and returned to the user. In one embodiment, an alternate temporary certificate can be used, such as is known by those of skill in the art. The user may then use the certificate for login in an automated or manual way with the authentication system.

This new framework provides better protection of cryptographic key material used for an interactive or network user login than current biometric implementations, such as the one described above. Advantages of the new framework include a cryptographic key inside a biometric sampling device may be used to protect the sample from tampering. This cryptographic key may be provided within integrated circuitry inside the biometric sampler. A key on the Biometric-Matching Server may be used for generating the temporary login certificate. This key resides on a physically secure server and is trusted by the network for creating credentials. The certificate that is given to the user for login is usable only for a very short time. And, this new framework is compatible with the current Kerberos/PKINIT authentication structure.

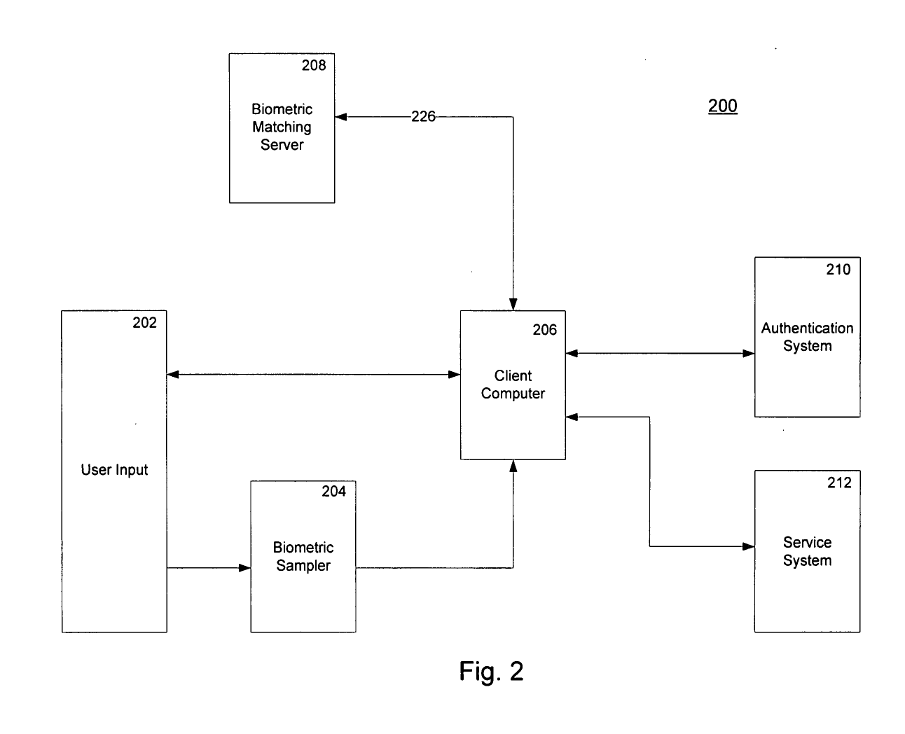

FIG. 2 is a block diagram showing functional aspects of the invention. A user input 202 is provided to both a client computer 206 and a biometric sampler 204. The user input is required in a biometric identification system to log onto the client to gain access to resources in a service server 212. In order to access the server 212, the user needs to be identified via the biometric sampler device 204 and the client computer 206 using a biometric matching server 208. In conjunction with an authentication system 210, the user may then be able to use the service server 212 if the user is authenticated.

In a typical scenario involving aspects of the invention, the user can begin an access of the client by entering a user ID and PIN or password. This forms part of the user input 202. Client computer 206 can prompt the user to present a biometric sample. In some systems, the biometric sample may simply be collected passively instead of actively. The biometric sampler 204 collects the biometric sample of the user. The biometric sampler 204 then cryptographically signs the biometric sample and forwards to the client computer system 206. The cryptographic signature is used to protect the biometric sample against tampering within the client computer. The digital cryptographic signature establishes origin authentication to the biometric device that has taken the sample. This action attests that a fresh sample from a known source is provided to the client.

The client computer 206 then establishes a secure connection 226 to the biometric matching server 208 and transfers the biometric sample information. In one embodiment, a secure socket layer (SSL) and or a transport layer security (TLS) connection is made between the client 206 and the biometric matching server 208 or other secure link method to protect the sample from tampering in transit.

Information sent from the client 206 to the biometric server 208 includes the digital signature, biometric sample, user input PIN and/or password, and timestamp and/or nonce. If this data matches reference data associated with the user in the database of the biometric matching server 208, then the biometric matching server generates a cryptographic public/private key pair and digital certificate, such as a x.509 certificate for the user login session. The digital certificate is constructed with a short validity period such that it will expire in a short time. The digital certificate and key pair are sent via a secure link from the biometric matching computer 208 to the client computer 206. In one aspect of the invention, a temporary digital certificate is issued so as to increase the security level in obtaining access to the services server 212 resources. Many biometric device readers or biometric systems store a permanent certificate in their biometric reader or client computer. This increases the risk of illegitimate access by presentation of a certificate used in a prior access. By generating a temporary or ephemeral certificate recognized by the authentication system, the freshness of the biometric reading and the strength of the certificate are enhanced. An ephemeral certificate that is temporary in viability is more secure because it cannot be re-used to acquire more than one set of authentication system credentials in a fixed time period. In one embodiment, the fixed time period may be fixed at time interval from ten minutes to several hours. Hence, the certificates are unique for the particular authentication session. Failure to use the temporary certificate within the allotted time for authentication system access will result in denial of authentication system access due to the expiration of the certificate.

Once the key(s) and certificate have been issued, the client 206 can go forward to authenticate itself to a secure system 210 which in an exemplary implementation would be a Kerberos KDC (Key Distribution Center). An example authentication system is the Kerberos system. In one Kerberos authentication embodiment, the client presents the user ID, certificate, and signature as an authentication request to the Kerberos Authentication server (see FIG. 1) using the current PKINIT protocols. If the PKINIT authentication protocol succeeds, a user token containing a Kerberos Ticket Granting Ticket (TGT) is issued to the client 206 for subsequent use in the Kerberos-based network. The client 106 may at that time discard the temporary PKI certificate and key or key pair. The client 206 is then free to gain access to the service server 212 via further Kerberos access protocols.

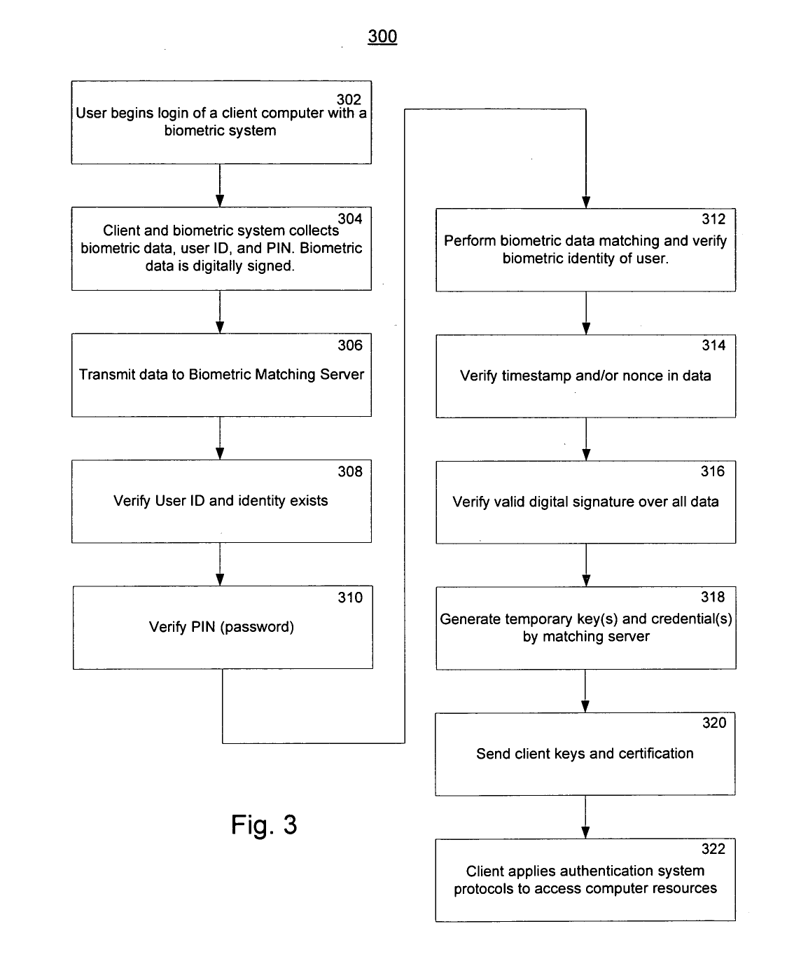

FIG. 3 is a flow diagram depicting a method 300 of using a biometric device in conjunction with an authentication system. The process begins by a user starting a login session of a client computer that uses a biometric identification system (step 302). In one embodiment, an interactive process is encountered where the client computer prompts the user to provide a biometric sample. In another embodiment, the biometric sampling device collects a sample passively. In either case, the client collects the users ID, personal identification number (PIN), and or password (step 304). Some biometric systems may require both a PIN and a password, while others may require neither. But, the inclusion of a PIN and/or password adds further authority and trust to the process of collecting user credentials in a biometric sampling system because it requires the cooperation of the user and can be indicative of live data. In some systems a PIN or password may be required both locally by the biometric sampling device and by the remote biometric matching server.

As a further security measure, the biometric data collected from the user is digitally signed. This digital signature of the biometric data indicates that a particular biometric sampling device was used to collect the data. For example, if a biometric device data that is not recognized by the client computer is presented, the client computer can reject the biometric data based on a failure of the client to recognize the sampling device used. In addition, a timestamp may be added to the biometric sample to attest to the freshness of the biometric sample data. For example, if time-stale data is presented to the client computer, the client computer may reject the biometric data as being old and possibly fraudulently submitted. As a further alternative, a nonce may be added along with or in lieu of a timestamp. In the instance where a timestamp and/or nonce is/are added, the digital signature may be applied to all of the collected data.

After collecting the user credentials and biometric data, a secure link is developed with the biometric matching server and the client computer securely transmits the collected data (step 306). The secure link may be established using a private key from the client to the biometric matching server. The private key used may come the biometric server if the key was given to the client in a secure transaction. Alternately, the private key could have securely provisioned by an external authority and given to the client. The client then uses the private key to encrypt the page a of data which includes the signed biometric data, the user ID and PIN or password, and the timestamp or nonce.

At the biometric server, many checks of the collected data are performed. The checks of step 308-316 may be performed in any logical order. In one embodiment, the package of biometric data and user credentials, along with timestamp and nonce data is examined for validity. The user ID is checked and matched with a list of authorized users listed in the biometric matching server (step 308). At this step, the biometric matching server verifies that a user matching the identity information exists. If the user does not exist the process 300 fails and the user logon terminates.

If password or PIN information was presented along with the biometric data collection, the information is verified as belonging to the authorized user (step 310). As before, if the validation of the user PIN or password information is invalid, the process 300 fails and the user logon terminates. Next, the biometric data itself is matched (step 312). The comparison of the submitted biometric data is preferably performed against a secure template of biometric data available via the biometric matching server. The template information may be provisioned by any secure means known to those of skill in the art. If the biometric match does not yield a statistically significant correlation or match, the process 300 fails and the user login terminates.

Another verification of the biometric data may be performed (step 314) if a timestamp or nonce was submitted or added at the time of biometric data collection. This timestamp or nonce data helps ensure that the biometric data obtained is fresh and not merely copied and resubmitted. In one embodiment, the nonce or timestamp may be generated by the biometric sampling device itself or by the client computer. In either case, the timestamp or nonce data may be added as a hardware added stamp on the biometric sample data as an indication of a recently collected sample. The hardware may be in integrated circuit in the biometric sampling device that adds a timestamp, nonce, and/or digital signature.

Another verification of the biometric data is the confirmation that the digital signature added by the biometric sampling device (step 316) authenticates the biometric device. If the biometric matching server does not recognize that the biometric sampling device indicated via the digital signature is one associate with the client computer, then the process 300 fails and the user login is terminated. The digital signature can also be used to verify that the biometric data and the timestamp and/or nonce have not been manipulated after generation by the sampling device.

Upon verification that the package of information given to the biometric matching server meets all of the criteria for acceptance, then keys and at least one temporary credential or certificate are generated (step 318). The biometric matching server generates a public/private key pair for use by the client. The public/private key pair is not limited by any specific cryptographic algorithm such as RSA, ECC, DH, or any other type as known to those of skill in the art. All types of cryptographic means compatible with the client and authentication system are useable in the present invention. Similarly, the certificate format is not limited to X.509. The format can be XrML, ISO REL, SAML, or any other format known to those of skill in the art. All types of digital certificates may be used provided that they are compatible with the client and authentication system. In addition, the cryptographic keys and methods used in any connection between functions such as the client, the biometric matching server, the authentication system, and the service server may be either symmetric or asymmetric.

The cryptographic keys used in the biometric readers, scanning or sampling devices may be provisioned during manufacture or they may be provisioned by an organization using a cryptographic key hierarchy, public key infrastructure, or other external authority. The cryptographic keys generated on the biometric matching server may be generated in software, they may be generated using a hardware devices such as an HSM or accelerator, they may be generated using a pre-computed list of keys loaded from an external source traceable to a key authority.

Returning to FIG. 3 and process 300, after generation of the keys and certificate, the keys and certification are given to the client (step 320). In general, all of the information uploaded to the biometric matching server are returned along with the keys and certification. This permits the client to have access to the user credentials (user lD, PIN, and or password) without storing the data on the client computer. After the client receives the keys and certificate and returned credentials from the biometric matching server, then the client can then apply the received information to the authentication system to access the desired computer resources (step 322). Here, embodiments of the invention may vary depending on the nature of the authentication system. In one embodiment, the Kerberos authentication protocols are used.

In one embodiment, the client may initiate a Kerberos protocol as described above with respect to FIG. 1. As an element in the protocol, the client will eventually present the temporary certificate, user ID, PIN and or password, and cryptographic keys and transmit the information to a Kerberos ticket granting server to request service tickets so that access to computer resources via the protected service server is granted. Other embodiments may use different protocols as demanded by the needs of the specific authentication server used.

In one alternative to the method of FIG. 3, the user ID, PIN and or password and biometric sample may be validated locally by a hardware device first prior to sending the data to the biometric matching server. In another alternative, all of the data may be collected by the client and passed to the server and validated only by the server in a secure process.

In one embodiment of the method FIG. 3, the transmittal of a data package (step 306) to the biometric server also includes a public key that is part of a private/public key pair generated by the client computer 206. The public key sent in the data package to the biometric server is certified by the biometric server before being sent back (step 320) along with a credential, such as a digital certification, to the client computer 206.

In one embodiment of the invention, the functions of FIG. 2 may be combined in various forms. For example, the client 206 and biometric matching server may be combined, or the authentication system 210 and the client computer may be combined, or the biometric sampler 204 and client computer 206 may be combined, or the authentication server 210 and the biometric matching server 208 may be combined. Although the functional blocks of FIG. 2 may be combined in a variety of ways, the overall function of the resulting system 200 remains intact.

### Exemplary Computing Device

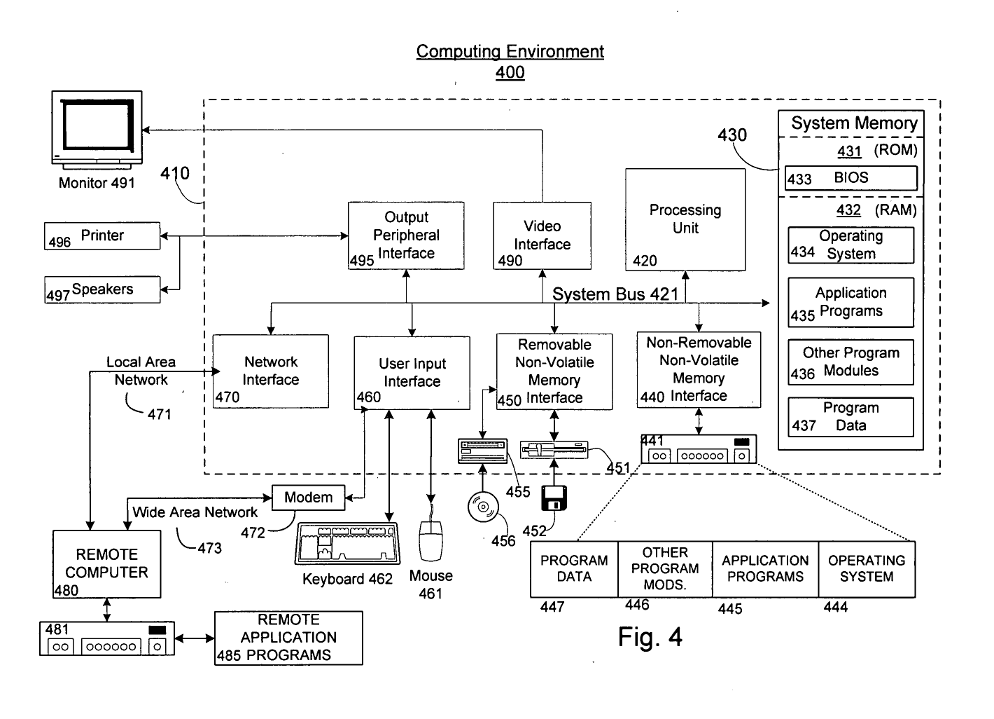

FIG. 4 and the following discussion are intended to provide a brief general description of host computer suitable for interfacing with the media storage device. While a general purpose computer is described below, this is but one single processor example, and embodiments of the host computer with multiple processors may be implemented with other computing devices, such as a client having network/bus interoperability and interaction.

Although not required, embodiments of the invention can also be implemented via an operating system, for use by a developer of services for a device or object, and/or included within application software. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that various embodiments of the invention may be practiced with other computer configurations. Other well known computing systems, environments, and/or configurations that may be suitable for use include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. Embodiments of the invention may also be practiced in distributed computing environments where tasks are performed by remote processing devices that are linked through a communications network/bus or other data transmission medium. In a distributed computing environment, program modules may be located in both local and remote computer storage media including memory storage devices and client nodes may in turn behave as server nodes.

With reference to FIG. 4, an exemplary system for implementing an example host computer includes a general purpose computing device in the form of a computer system 410. Components of computer system 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures.

Computer system 410 typically includes a variety of computer readable media. Computer readable media can be any available media that can be accessed by computer system 410 and includes both volatile and nonvolatile media, removable and non-removable media. By way of example, and not limitation, computer readable media may comprise computer storage media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 410.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer system 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 433, application programs 435, other program modules 436, and program data 437.

The computer system 410 may also include other removable/non-removable, volatile/nonvolatile computer storage media. By way of example only, FIG. 4 illustrates a hard disk drive 431 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4 provide storage of computer readable instructions, data structures, program modules and other data for the computer system 410. In FIG. 4, for example, hard disk drive 441 is illustrated as storing operating system 444, application programs 445, other program modules 446, and program data 447. Note that these components can either be the same as or different from operating system 444, application programs 445, other program modules 446, and program data 447. Operating system 444, application programs 445, other program modules 446, and program data 447 are given different numbers here to illustrate that, at a minimum, they are different copies.

A user may enter commands and information into the computer system 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490, which may in turn communicate with video memory (not shown). In addition to monitor 491, computer systems may also include other peripheral output devices such as speakers 497 and printer 496, which may be connected through an output peripheral interface 495.

The computer system 410 may operate in a networked or distributed environment using logical connections to one or more remote computers, such as a remote computer 480. The remote computer 480 may be a personal computer, a server, a router, a network PC, a peer device or other common network node, and typically includes many or all of the elements described above relative to the computer system 410, although only a memory storage device 481 has been illustrated in FIG. 4. The logical connections depicted in FIG. 4 include a local area network (LAN) 471 and a wide area network (WAN) 473, but may also include other networks/buses. Such networking environments are commonplace in homes, offices, enterprise-wide computer networks, intranets and the Internet.

When used in a LAN networking environment, the computer system 410 is connected to the LAN 471 through a network interface or adapter 470. When used in a WAN networking environment, the computer system 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer system 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, includes servers, building-block services, such as Web-based data storage, and downloadable device software. While exemplary embodiments herein are described in connection with software residing on a computing device, one or more portions of an embodiment of the invention may also be implemented via an operating system, application programming interface (API) or a “middle man” object between any of a coprocessor, a display device and a requesting object, such that operation may be performed by, supported in or accessed via all of .NET™'s languages and services, and in other distributed computing frameworks as well.

As mentioned above, while exemplary embodiments of the invention have been described in connection with various computing devices and network architectures, the underlying concepts may be applied to any computing device or system in which it is desirable to implement a biometric credential verification scheme. Thus, the methods and systems described in connection with embodiments of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by embodiments of the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention.

While aspects of the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the claimed invention should not be limited to any single embodiment, but rather should be construed in breadth and scope in accordance with the appended claims.

1. A method of verifying biometric credential in conjunction with an authentication system, the method comprising:
receiving a data package, the data package comprising biometric sample data, a user identification (ID), and at least one of a personal identification number (PIN) and a password associated with a user, the sample data having a digital signature verifying the origin of the sample data;
verifying, at a biometric matching server, that the user ID is associated with an authorized user, that the user PIN or password is valid, that the sample data matches a template of data of the authorized user, and that the digital signature is valid;
generating a temporary credential and at least one cryptographic key; and
transmitting the temporary credential and the at least one cryptographic key along with the data package to a client computer, wherein the temporary credential and the at least one cryptographic key allows for accessing a secure authorization system that verifies the temporary credential, authenticates the user and, upon successful authentication, grants the user subsequent access to secured resources.

2. The method of claim 1, further comprising receiving the biometric sample data, a timestamp, and the digital signature from a biometric sampling device.

3. The method of claim 1, wherein receiving a data package comprises receiving the data package over a secure link.

4. The method of claim 3, wherein the data package further comprises a client-generated public key and wherein the method further comprises certifying the client-generated public key before transmitting the temporary credential to the client computer.

5. The method of claim 1, wherein generating a temporary credential and at least one cryptographic key comprises generating, at the biometric matching server, a temporary certificate and a public/private key pair compatible with the authentication system.

6. The method of claim 5, wherein the public/private key pair is securely provisioned to the biometric matching server.

7. The method of claim 5, wherein the authentication system is the Kerberos authentication system.

8. The method of claim 1, wherein accessing a secure authorization system comprises accessing a Kerberos system using a temporary certificate and a public/private key pair to obtain subsequent access to resources of a service server, wherein the temporary certificate format comprises one of X.509, XrML, ISO REL, or SAML.

9-17. (canceled)

18. A computer-readable medium having computer-executable instructions for performing a method of verifying biometric credential in conjunction with the Kerberos type authentication system, the method comprising:
receiving a data package, the data package comprising biometric sample data, a user identification (ID), and at least one of a personal identification number (PIN) and a password associated with a user, the sample data having a digital signature verifying the origin of the sample data;
verifying that the user ID and PIN are associated with an authorized user, that the sample data matches a template of data of the authorized user, and that the digital signature is valid;
generating a temporary credential and a public/private key pair; and
transmitting the temporary credential and the key pair along with the data package, wherein the temporary credential and the at least one cryptographic key allows for accessing a secure authorization system that verifies the temporary credential, authenticates the user and, upon successful authentication, grants the user subsequent access to secured resources.

19. The computer-readable medium of claim 18, wherein the method further comprising receiving the biometric sample data, at least one of a timestamp and a nonce, and the digital signature from a biometric sampling device.

20. The computer-readable medium of claim 18, wherein the method further comprising accessing the Kerberos type authorization system using a temporary certificate and a public/private key pair to obtain subsequent access to resources of a service server, wherein the temporary certificate format comprises one of X.509, XrML, ISO REL, or SAML.

21. A computer system for verifying biometric data comprising:
a memory component for storing biometric templates of users; and
a processor in operative communication with the memory component, wherein the processor executes the program code, and wherein execution of the program code directs the system to:
receive a data package from a client computer, the data package comprising biometric sample dataand a user identification;
validate information in the data package that the user identification is associated with an authorized user and that the sample data matches a template of data of the authorized user; and
return the data package to the client computer along with a temporary credential to access an authentication system that verifies the temporary credential, authenticates the user and, upon successful authentication, grants the user subsequent access to secured resources.

22. The system of claim 21, further comprising:
a biometric sampling device for sampling biometric data of a user and providing the sampled biometric data along with a digital signature verifying the origin of the sample data to the client computer, wherein the data package further comprising the digital signature.

23. The system of claim 22, wherein execution of the program code further directs the system to validate the digital signature.

24. The system of claim 22, wherein the biometric sampling device further supplies a time tag to accompany the sampled biometric data along with the digital signature.

25. The system of claim 21, wherein the data package further comprises at least one of a personal identification number or a password associated with a user, and wherein execution of the program code further directs the system to validate at least one of the personal identification number or the password.

26. The system of claim 21, wherein the temporary credential is valid for one authentication session with the authentication system.

27. The system of claim 21, wherein the authentication system is a Kerberos authentication system.

28. The system of claim 21, wherein the at least one key to access the authentication system comprises a public/private key pair.
